(19) United States
(12) Patent Application Publication
(10) Pub. No.: US 2010/0086824 A1
(43) Pub. Date: Apr. 8, 2010

(54) ASSEMBLIES OF HOLLOW ELECTRODE ELECTROCHEMICAL DEVICES

(76) Inventors: Michael Homel, Salt Lake City, UT (US); Michael Gardiner, Grantsville, UT (US); Jared Rich, Salt Lake City, UT (US)

Correspondence Address: JAMES SONNTAG;JAMES SONNTAG, PATENT ATTORNEY, P.O. BOX 9194, SALT LAKE CITY, UT, 84109, US

(21) Appl. No.: 12/553,969

(22) Filed: Sep. 3, 2009

Related U.S. Application Data
(60) Provisional application No. 61/093,828, filed on Sep. 3, 2008.

(51) Int. Cl. H01M 8/10

(52) U.S. Cl. 429/30

(57) ABSTRACT

This disclosure relates to a compact and thermally integrated structure for assemblies of hollow electrode electrochemical devices (HEED), such as solid oxide fuel cells, solid oxide electrolysis cells, and solid oxide ion transport membranes, for providing a means for electrical interconnection between multiple cells, and manifolds for reactant and product streams. The HEED comprises an inner electrode chamber, inner current collector, inner electrode, electrolyte, outer electrode, outer current collector, and outer electrode chamber. The system comprises a plurality of HEED, arranged in a parallel array, mechanically supported by one or more header plates, where a primary header plate encompasses a portion of a gas manifold connected to the inner chamber of the HEED. The HEED pass through the primary header plate, into the primary manifold chamber wherein electronic connections are formed between the inner current collector and outer current collectors of the HEED to allow for series, parallel, or series-parallel electrical configurations. The system is operated such that the temperature and atmosphere surrounding the interconnect assembly in the primary manifold chamber are conducive to the use of metallic interconnect materials. The outer electrode chamber of the HEED is housed in a manifold that may be thermally integrated with a heat exchanger, fuel reformer, tailgas combustor, or auxiliary heat source.

### RELATED APPLICATIONS

This application claims priority from U.S. Provisional Application 61/093,828, filed 3 Sep. 2008, which is hereby incorporated by reference.

### FEDERAL RESEARCH STATEMENT

This invention was made with support from the United States Federal Government, and the United States Federal Government has certain rights in this invention pursuant to Office of Naval Research prime contract number N00014-05-C-0051, contract number 2005-02.

### BACKGROUND

This invention relates to systems of hollow electrode electrochemical devices (HEED) such as solid oxide fuel cells, solid oxide electrolysis cells, fuel assisted electrolysis cells, and ion transport membranes.

A common structure for electrochemical devices is a hollow electrode geometry, in which the inner electrode of the HEED may be the anode or cathode of the electrochemical cell, and in which the support for said cell may be the anode, cathode, electrolyte, current collector or other gas permeable media. In general, solid oxide electrochemical devices comprise a pair of porous electrodes, (anode and cathode) separated by a dense, solid-phase, ceramic electrolyte. Devices are operated at elevated temperature, typically in the range of 600-1000° C. wherein the ionic conductivity of the electrolyte material is high. Typical electrolyte materials for solid oxide fuel cells (SOFC) and solid oxide electrolysis cells (SOEC) are yttria-stabilized zirconia, (YSZ), scandia-stabilized zirconia (ScSZ), Sr-doped and Mg-doped LaGaO₃ (LSGM) and related compositions, samaria-doped ceria (SDC), and gadolinium-doped ceria (GDC), where the materials must have high ionic conductivity of negative oxygen ions, low electronic conductivity, chemical and physical stability in the operating environment, and compatible fabrication processes with the electrode materials.

For a SOFC, the anode chamber is typically supplied a fuel that may include hydrogen, carbon monoxide, ammonia, methane, or other light hydrocarbons, as pure species or as mixtures that may be diluted by other species such as carbon dioxide, nitrogen, and steam. The fuel may be supplied by a fuel reformer that breaks down heavy hydrocarbon fuels such as diesel, kerosene, methanol, ethanol, or carbonaceous feedstocks into a fuel suitable for oxidation in the SOFC. The fuel reformer process may be exothermic (as in the case of partial oxidation reformation of diesel fuel), endothermic (as in the case of steam reformation of natural gas), or adiabatic (as in the case of autothermal reforming of methanol). On many systems, fuel is supplied to the SOFC at an elevated temperature from either a fuel reformer or a preheater. For a SOFC, the cathode chamber is typically supplied oxygen, either pure or in a dilute form such as air from the ambient surroundings. Typically air is preheated before entering the cathode chamber. Fuel passing over the anode reacts with oxygen ions transported through the electrolyte to produce electrons that are transported through an external circuit, driving an external load, and being incorporated into the electrolyte at the cathode.

Typical SOFC reactions that occur include:

At the anode: H₂+O²⁻→H₂O+2e⁻, CO+O²⁻→CO₂+2e⁻,

And at the cathode: O₂+4e⁻→2O²⁻.

A typical SOFC anode comprises a mixed ionic- and electronic-conducting material having sufficient porosity to allow gas transport from the anode chamber to the anode-electrolyte interface, sufficient catalytic activity to promote the charge transfer reactions at the anode-electrolyte interface, sufficient electronic conductivity to provide electronic pathway from the anode-electrolyte interface to the external circuit, and chemical and physical stability in a reducing atmosphere, in contact with other cell materials, and at the operating temperature range. To increase performance, the anode may comprise a varied composition with one or more materials and layers that may include: an anode functional layer having increased catalytic activity and a high ionic conductivity to extend the reaction region from the electrolyte surface and decrease the effective charge transfer resistance at the electrode-electrolyte interface, a current collector having high porosity and electronic conductivity, and a contact layer promoting electronic transfer form the bulk electrode to the external circuit or electronic interconnect in a multi-cell assembly. A typical composition may be an anode functional layer comprising a finely structured nickel-YSZ cermet having a high YSZ content, an anode current collector comprising a more coarsely structured, highly-porous, nickel-YSZ cermet having high nickel content, and a contact layer comprising woven wire gauze of nickel or copper.

A typical SOFC cathode comprises a mixed ionic- and electronic-conducting material having sufficient porosity to allow gas transport from the cathode chamber to the cathode-electrolyte interface, sufficient catalytic activity to promote the charge transfer reactions at the cathode-electrolyte interface, sufficient electronic conductivity to provide electronic pathway from the cathode-electrolyte interface to the external circuit, and chemical and physical stability in an oxidizing atmosphere, in contact with other cell materials, and at the operating temperature range. To increase performance, the cathode may comprise a varied composition that may include: an optimized cathode functional layer having increased catalytic activity and a high ionic conductivity to extend the reaction region from the electrolyte surface and decrease the effective charge transfer resistance, a current collector having high porosity and electronic conductivity, and a contact layer promoting electronic transfer from the bulk electrode to the external circuit or electronic interconnect in a multi-cell assembly. A typical composition may be a cathode functional layer comprising a finely structured strontium-doped lanthanum manganate (LSM)-YSZ cermet having a high YSZ content, a cathode current collector comprising a more coarsely structured, highly-porous, strontium-doped lanthanum cobaltite (LSC)-YSZ cermet having high LSC content, and a contact layer comprising woven wire gauze of silver or stainless steel.

Solid oxide electrolysis cells (SOEC) may be similar in composition to SOFC, but with an alternate electrode composition or structure depending on operating conditions. In a solid oxide steam electrolysis cell, steam is supplied to the cathode chamber, which is decomposed at the electrolyte into hydrogen that vents to the cathode outlet, negative oxygen ions that transport across the electrolyte to the anode chamber, and electrons, that are transported through the external circuit. At the anode, the oxygen ions combine with electrons from the external circuit to produce oxygen. In this mode electric energy is consumed to produce hydrogen and oxygen from steam. In this mode of operation, the anode chamber is an oxidizing environment. If the cathode chamber is fed pure steam an oxidizing atmosphere will exist at the inlet or throughout the chamber when at open circuit conditions. When hydrogen is being produced, the atmosphere at the outlet and throughout most of the chamber will be reducing, and the system may be operated with a small amount of hydrogen in the feedstock stream to maintain a reducing atmosphere throughout. The electrode composition of the SOEC anode may be similar to that of the SOFC cathode described above, and the electrode composition of the SOEC cathode may be similar to the electrode composition of the SOFC anode described above.

Typical SOEC reactions that occur include:

$$At the anode \text{:} {O}^{2 -} \to \frac{1}{2} {O}_{2} + 2 {e}^{-} , \\ And at the cathode \text{:} {H}_{2} O + 2 {e}^{-} \to {O}^{2 -} + {H}_{2} .$$

Solid oxide fuel-assisted electrolysis cells (SOFEC) may operate in a fashion similar to the SOEC described above, but with a fuel supplied to the anode chamber such as those described above as feedstocks to the SOFC anode chamber. Negative oxygen ions transporting through the electrolyte chamber react with the fuel stream and release electrons to the external circuit. The presence of the fuel in the anode chamber creates a chemical potential difference to drive the electrolysis reaction reducing or eliminating the required electrical input and allowing the energy in a variety of fuel sources to be converted into clean hydrogen at a high efficiency. The SOFEC may also be used to purify hydrogen by supplying an impure hydrogen stream to the anode chamber to produce pure hydrogen at the cathode chamber. The hydrogen produced is of a high purity for use in low temperature proton exchange membrane fuel cells without secondary purification processes. The electrode composition and operating conditions of the SOFEC anode may be similar to that of the SOFC anode described above, and the electrode composition of the SOFEC cathode may be similar to the electrode composition of the SOFC anode described above.

Typical SOFEC reactions that occur include:

At the anode: H₂+O²⁻→H₂O+2e⁻, CO+O²⁻→CO₂+2e⁻,

And at the cathode: H₂O+2e⁻→O²⁻+H₂.

A reversible electrolysis cell may operate as a SOFC to produce power from a supplied fuel, or may be operated to produce hydrogen in either a SOEC or SOFEC mode. Typically the electrode composition of one electrode may be similar to the electrode composition of the SOFC anode described above, and this electrode functions as the anode in SOFC mode, the cathode in SOEC mode, and as either the anode or the cathode in SOFEC mode. The second electrode comprises an alternate composition allowing it to operate under reducing conditions or mixed oxidizing and reducing conditions as the SOFEC cathode, and under oxidizing conditions as the SOFC cathode or SOEC anode. A typical composition may be a functional layer comprising a finely structured strontium-doped lanthanum cobalt manganate (LSCM)-YSZ cermet having a high YSZ content, a cathode current collector comprising a more coarsely structured, highly-porous, LSCM-YSZ cermet having high LSC content, and a contact layer comprising woven wire gauze of silver or stainless steel.

Other types of ion transport membranes may have electrolyte and electrode structures and compositions similar to one or more of the devices described above such that the system configuration described in this invention is relevant.

Electrochemical devices are operated such that the anode and cathode chambers are supplied suitable reactant streams, suitable operating temperatures are maintained, and so that gasses in the anode chamber, cathode chamber, and gas manifolds are prevented from intermixing. Terminal lead wires connect the electrode current collectors to the external circuit, which may be an external load, or an applied voltage.

For electrochemical devices operating at elevated temperatures, hollow electrode geometries offer many benefits relative to planar cell geometries including resistance to thermal stress failures, ease of gas sealing, ease of fabrication, and low fluid resistance. Thus the hollow electrode electrochemical device (HEED) has many applications. A HEED comprises an inner electrode and outer electrode and may be constructed and operated such that the inner electrode is the cathode and the outer electrode is the anode, or such that the inner electrode is the anode and the outer electrode is the cathode.

For many applications it is desirable to assemble an array of hollow electrode electrochemical devices such that the flow is distributed in a parallel fashion and such that the cells are connected electrically in-series, or in a series-parallel array. Parallel flow distribution reduces the parasitic losses associated with reactant delivery of the system and in many cases leads to a more compact assembly. Series electrical connections allow for higher-voltage, lower-current electrical flow through the system for a given power level, typically resulting in a higher energy conversion efficiency, lower materials cost, and a more compact system. Series-parallel configurations offer the advantages of a series-connected system but with increased reliability.

In series-connected HEED, it is necessary to form a conductive electronic interconnect from the inner electrode of one cell to the outer electrode of the adjacent cell. This presents challenges due to the difference in gas composition in each chamber, which may require: (1) that the electronic interconnect or one or both of the HEED current collectors be stable and conductive in both oxidizing and reducing atmospheres; and (2) that gas seals around the interconnect prevent intermixing of gas species while possessing suitable mechanical and chemical stability.

For high temperature SOFC operating near 1000° C., ceramic interconnect materials comprising strontium-doped lanthanum chromite (LSCr) have been used, but there exist economic and performance incentives for using metallic interconnects and operating at intermediate temperatures in the range of 650-850° C. At these temperatures, inexpensive metals may not have suitable chemical stability under oxidizing conditions.

A system may be configured such that the electronic interconnections and gas seals can are located in a lower temperature zone where less expensive materials and manufacturing process can be applied. However this option requires that a length of the HEED or current collector extend from the hot zone through an intermediate temperature region where electrochemical operation is either infeasible or inefficient due to the lower temperature and associated low ionic conductivity of the electrolyte material. This may result in undesirable system characteristics including a higher system cost and lower power density. Additionally the hot gasses entering or exiting the HEED make it difficult to integrate the HEED array with a cold zone interconnect assembly without compromising compactness or efficiency of the system.

A system may be configured with gas seals interconnected in the hot zone by fabricating the cells such that a portion of the inner electrode surface is exposed through the electrolyte layer and outer electrode such that it may be connected to the cathode of an adjacent cell using a suitable material, and such that the interconnect region is sealed to prevent intermixing of gasses in the inner and outer electrode chambers. An example of this system has been developed by Siemens and Westinghouse. Fabricating assemblies of this type may require expensive and elaborate equipment resulting in an undesirably high system cost. Additionally, the interconnects running the length of the cell may render the system intolerant to differential thermal expansion caused by the thermal gradients that may exist during steady state or transient operation. This factor may prevent this type of configuration from being successfully applied to systems requiring fast or frequent thermal cycles such as those for portable or distributed operation.

### SUMMARY

Described is an approach for fabricating systems comprising a plurality of HEED connected in series or in a series-parallel configuration, for mechanical support for the HEED, for gas manifolds for the reactant and products streams, and for seals that promote gas separation between the inner and outer electrode chambers. The described system allows for construction of compact systems for portable and distributed systems for applications such as power generation, and hydrogen generation.

According to one aspect there is provided an electrochemical system comprising a plurality of HEED wherein the inner electrode is operated in a reducing atmosphere. This inner electrode may be the anode of a SOFC, the cathode of a SOEC, the anode of a SOFEC, or the cathode of a SOFEC. The HEED are arranged in a geometrically parallel array, connected to a primary header plate such that a length of the HEED, or an electronically conductive extension thereof passes though openings in the header plate. The HEED or extension thereof is sealed to the primary header plate such that one side of the plate faces the outer electrode chamber of the HEED assembly. A manifold is attached to the second face of the primary header plate such that the manifold and the primary header plate enclose a region from which species may flow to or from the inner chamber of the HEED array. This region houses the electrical interconnection between HEED, connected to the inner and outer electrodes of the HEED, or to electronically conductive extensions or contact layers attached to the HEED electrodes. The system is operated such that the region surrounding the interconnect assembly is a reducing atmosphere, and the interconnects may comprise low cost metallic materials such as copper, nickel, or alloys thereof.

The system may include one or more additional header plates that may provide lateral support to the HEED array, while allowing axial translation to allow for differential thermal expansion between HEED during steady state or transient operating conditions.

The HEED may be open at both ends such that gas enters the inner electrode chamber at one opening, flows the length of the cell and exits at the second opening. Alternatively the HEED may be closed at one end and the anode chamber may contain a feed tube that may function as either the inlet or outlet to the inner chamber, such that the flow travels the length of the inner electrode chamber.

For a HEED with two open ends, a secondary header plate may connect to the HEED at the end opposite to that of the primary header plate such that a length of the HEED or an extension thereof pass through the secondary header plate, and one side of the secondary header plate faces the outer electrode chamber of the HEED array. A manifold may be attached to the second face of the secondary header plate such that the manifold and secondary header enclose a region from which gas may flow into or out of the inner chamber of the HEED array.

For a HEED with one open end, the feed tube may extend past the opening of the HEED, through the primary manifold chamber formed by the primary header plate and the manifold shell, pass into a secondary manifold such that seals around the feed tubes prevent intermixing of the gasses in the primary and secondary manifold chambers.

The primary and secondary manifold chamber may be either the inlet or outlet depending no system type, configuration, and operating mode.

The outer electrode of the HEED array may be the cathode of a SOFC, the anode of a SOEC, the cathode of a SOFEC, or the anode of a SOFEC.

If the HEED is a SOFC operated with pure oxygen fed to the cathode, the outer chamber of the HEED may be enclosed in a manifold comprising a shell with one or more inlet conduits. If the HEED is a SOEC producing pure oxygen at the anode the outer chamber of the HEED may be enclosed in a manifold comprising a shell with one or more outlet conduits. If the HEED has a single open end, the outer chamber manifold shell may be sealed to the primary header plate. If the HEED has two open ends, the outer chamber manifold shell may be sealed to both the primary and secondary header plates, and may act as the structural member providing axial support to the secondary header plate.

If the HEED is a SOFC wherein the cathode is fed a dilute oxygen source, a SOFC wherein the cathode is supplied oxygen at oxidant utilization less than unity, or a SOFEC, the outer chamber manifold may comprise a shell, one or more inlet conduits, and one or more outlet conduits. The fluid flow in the outer chamber may be: (1) roughly parallel to the flow in the inner chamber of the HEED array, and may be co-directional or counter-directional relative to flow in the inner electrode chamber; or (2) roughly perpendicular to the flow in the inner chamber in a cross-flow configuration.

In a parallel flow configuration, one or more diffuser plates may be used to improve the distribution of flow in the outer chamber. In a parallel co-flow configuration, the secondary header may contain one or more conduits to allow the flow of gas from the outer chamber into the secondary manifold. The secondary manifold may be configured such that the outlet flows from the inner and outer chamber remain separated, or in the case of a SOFC system, the secondary manifold may be configured to allow intermixing of the product streams, resulting in partial or complete combustion of the unspent fuel exhausted from the anode chamber.

The outer chamber manifold may comprise or be coupled to a heat exchanger or preheater using heat from the product streams, external source, or direct heat transfer from the HEED array to preheat the inlet flow.

If the HEED is a SOFC, or SOFEC, the fuel may be supplied to the anode from a reformer that may feed directly into the inner chamber inlet manifold. If the reformer is exothermic, the system may be configured such that heat is transferred from the pre-reformer to the HEED array, or if the reformer is endothermic the system may be configured such that heat is transferred from the HEED to the reformer.

In one embodiment of an aspect, the inner chamber inlet manifold is fed by a support tube housing a fuel reformer catalyst bed, such that fuel enters said catalyst bed and is reacted to form a gaseous fuel suitable for direct oxidation in the SOFC or SOFEC anode. This reformer support tube may pass through the outer electrode chamber of the HEED array, such that radiative and convective heat transfer may occur between the HEED and reformer.

Electronic leads are connected to the cells at the terminal electrodes of the cells at each end of the series or series-parallel assembly. One or more additional leads may be attached to electrodes, current collectors or interconnects at intermediate points in the series to allow for variable voltage output, or bypassing of faulty or poorly performing cells. Electronically conducting elements of the manifold, supply tubing, surround structures may function as one or more of the electronic leads. Terminal connections to the electrodes may be made in the primary manifold chamber, within the secondary electrode chamber, or within the outer electrode chamber. Electronic leads may be insulated, or may be routed so as to avoid contact with cells or electrically conducting elements of the system.

### BRIEF DESCRIPTION OF DRAWINGS

FIG. 1 is a schematic of a Hollow Electrode Electrochemical Device showing: (1) Outer Electrode Chamber; (2) Outer Electrode Current Collector; (3) Outer Electrode; (4) Electrolyte; (5) Inner Electrode; (6) Inner Electrode Current Collector; and (7) Inner Electrode Chamber.

FIG. 2A shows a diagram of a HEED with two open ends

FIG. 2B shows a diagram of a HEED with a single open end and a feed tube within the inner electrode chamber

FIG. 3 shows a diagram of a primary heater plate showing: (8) Opening for Reformer Support tube; (9) Primary Header Plate; and (10) Opening for HEED.

FIG. 4 shows a diagram of a secondary header plate showing: (17) Secondary Header Plate; (18) Opening for HEED; (19) Conduit for Outer electrode chamber flow; and (20) Opening for reformer support tube.

FIG. 5 is a diagram of a simple primary header assembly showing: (2) Outer Electrode; (3) Electrolyte; (4) Inner Electrode; (15) Outer Electrode Terminal Lead; (12) Primary Manifold Chamber; (11) Interconnect; (16) Inner Electrode Terminal Lead; (9) Primary Header Plate; (13) Primary Manifold Shell; and (14) Gas Seal.

FIG. 6 is a schematic of an electronic interconnect of the type shown in FIG. 5 wherein the interconnection is made between the inner electrode of one HEED and the outer electrode of an adjacent HEED in which electrical contact is made between with a portion of the outer electrode surface, and portion of the inner electrode surface exposed through the electrolyte and outer electrode.

FIG. 7 is a schematic of an open-ended HEED of the type shown in FIG. 5 wherein a portion of the inner electrode surface is exposed through the electrolyte and outer electrode to provide a contact surface for the interconnect.

FIG. 8 is a schematic of a HEED system comprising an array 36 series-connected HEED of the type shown in FIG. 7 wherein the interconnections are of the type shown in FIG. 6.

FIG. 9 is a schematic of an electronic interconnect that assembles to the inner electrode of one HEED and the outer electrode of an adjacent HEED wherein electrical contact is made between with a portion of the outer surface of the outer electrode or outer electrode current collector, and portion of the inner surface of the inner electrode or inner electrode current collector.

FIG. 10 is a schematic of a HEED system comprising an array of 36 series-connected HEED of the type shown in FIG. 1, wherein the interconnections are of the type shown in FIG. 9.

FIG. 11 is a schematic of an electronic interconnect that is integral to the inner electrode current collector that assembles to the inner electrode of one HEED and the outer electrode of an adjacent HEED wherein electrical contact is made between the inner surface of the inner electrode and the outer surface of the outer electrode or outer electrode current collector.

FIG. 12 is a schematic of an electronic interconnect of the type shown in FIG. 5 wherein the interconnection is made between the inner electrode of one HEED and the outer electrode of an adjacent HEED in which electrical contact is made between with a portion of the outer electrode surface, and portion of the inner electrode surface exposed through the electrolyte and outer electrode, and wherein the set screw integral to the interconnect can be tightened to expand the interconnect against the contact surfaces of the HEED.

FIG. 13 is a schematic of an electronic interconnection between the inner electrode of one HEED and the outer electrode of a second HEED in which the inner electrode of one HEED is connected to a conductive extension tube that passes through the primary header plate, and wherein a wire that is connected to the outer electrode of the second HEED passes through an opening in the primary header plate and is attached to the conductive extension tube of the first HEED.

FIG. 14A is a diagram of a SOFC generating electricity with oxygen supplied to the cathode and hydrogen supplied to the anode.

FIG. 14B is a diagram of a SOEC generating hydrogen at the cathode under an applied electric potential with steam supplied to the cathode and oxygen produced at the anode.

FIG. 14C is a diagram of a SOFEC generating hydrogen at the cathode under an applied electric potential with steam supplied to the cathode and a hydrogen/carbon dioxide mixture supplied to the anode, with steam and carbon dioxide produced at the anode.

FIG. 15 is a diagram of a HEED Module wherein the flow in the inner and outer electrode is co-directional, the HEED are open ended, the primary manifold is the inlet to the inner electrode chambers of the HEED array, the primary manifold is fed by a reformer that is central to the HEED array, and the outlet gas streams from the outer and inner electrode chambers mix in the secondary manifold chamber. The diagram shows: (13) Primary Manifold Shell; (9) Primary Header Plate; (22) Outer Electrode Chamber Inlet; (21) Open-Ended, Single-Chamber, HEED; (25) Reformer Support Tube; (26) Outer Electrode Chamber Manifold Shell; (17) Secondary Header Plate; (23) Primary Manifold Chamber Inlet Flow; (24) Reformer Chamber; (28) Secondary Manifold Chamber; (27) Structural Bond; (14) Gas Seal; and (12) Primary Manifold Chamber.

FIG. 16 is a diagram of a HEED Module wherein the flow in the inner and outer electrode is co-directional, the HEED are open ended, the primary manifold is the inlet to the inner electrode chambers of the HEED array, the primary manifold is by a feed pipe from an external source, and the outlet gas streams from the outer and inner electrode chambers mix in the secondary manifold chamber.

FIG. 17 is a diagram of a HEED Module wherein the flow in the inner and outer electrode is perpendicular, the HEED are open ended, the primary manifold is the inlet to the inner electrode chambers of the HEED array, the primary manifold is by a feed pipe from an external source, the outlet gas stream from the inner electrode chamber exits through the secondary manifold into an outlet pipe, and the outlet stream from the outer electrode chamber exits through an outlet pipe connected to the outer electrode chamber manifold shell. The diagram shows: (23) Primary Manifold Inlet Flow; (31) Primary Manifold Inlet Tube; (21) HEED; (13) Primary Manifold Shell; (9) Primary Header Plate; (14) Gas Seal; (22) Outer Electrode Chamber Flow; (17) Secondary Header Plate; (30) Secondary Header Outlet Pipe; (28) Secondary Manifold Chamber; (29) Secondary Manifold Shell; and (12) Primary Manifold Shell.

FIG. 18 is a diagram showing a cross section of an HEED system of the type described in Example I showing: (1) Primary manifold shell; (2) Primary header plate; (3) Reformer support tube; (4) Inner electrode current collector of single-chamber, open-ended HEED; (5) Diffuser plate; (6) Outer electrode current collector; (7) Secondary header plate support bracket; (8,9) Outer electrode chamber fluid conduit; (10,11) Inner electrode chamber outlet; and (12) Secondary header plate.

FIG. 19 is a plot of the polarization response of the SOFC bundle described in Example II, showing the performance of a 36-Cell SOFC Bundle, tested with fuel supplied to the anode (inner electrode) comprising 42% hydrogen, bal. nitrogen, and air supplied to the cathode (outer electrode). The bundle is tested at 790° C., under a fixed flow equivalent to a fuel and air utilization of approximately 40% at 12 A.

FIG. 20 is a schematic showing a cross section of an HEED system of the type described in Example III showing: (21) Outer Electrode Chamber Manifold Tube; (1) Primary Header Plate; (12) Primary Manifold; (20) Secondary Manifold; (18) Primary Manifold Tube; (19) Secondary Manifold Tube; (17) HEED; (23) Outer Electrode Manifold Shell; and (22) Outer Electrode Chamber Manifold Tube.

FIG. 21A is a diagram of a HEED having a single open chamber, wherein the geometry of the HEED is an elongated cylindrical tube.

FIG. 21B is a diagram of a HEED having a single open chamber wherein the geometry of the HEED is a non-cylindrical geometry.

FIG. 21C is a diagram of a HEED having multiple inner electrode chambers and having a non-cylindrical geometry.

FIG. 21D is a diagram of a HEED having an inner chamber comprising a porous media having sufficient open connected porosity to allow for flow of the inner chamber fluid to and or from the electrode/electrolyte interface and the inlet or outlet of the HEED.

### DETAILED DESCRIPTION

### Definitions

The following terms have the following meanings, unless otherwise indicated. All terms not listed have their common art meanings.

The term “current collector”, as in “anode current collector”, “cathode current collector”, “inner electrode current collector”, or “outer electrode current collector” refers to any component, electrode layer, wire, mesh, porous media, or other element or combination of elements in contact with the electrode or electrode functional layer surface and functioning as an electronically conductive pathway from the electrode or electrolyte surface to an external circuit, current lead, or electronic interconnect.

The term “functional layer”, as in “cathode functional layer”, “anode functional”, “inner electrode functional layer”, or “outer electrode functional layer” refers to the region at the interface of the electrode and electrolyte where the charge transfer reactions occur. The effective length that this region extends from the electrolyte is determined by the local charge transfer resistance, the ionic and electronic conductivity of the region.

The term “interconnect”, used as a noun describes the electronically conducting element or assembly of elements used to connect the anode or anode current collector of one cell to the cathode or cathode current collector of an adjacent cell in a series connection or to connect the anode, anode current collector, cathode, or cathode current collector of a cell to same electrode or current collector type of an adjacent cell in a parallel connection.

The term “reformer” is used to describe any chemical reactor or combination of chemical reactors used to modify a feedstock fuel into a product suitable for oxidation in the anode of a SOFC or SOFEC.

The term “cermet” refers to a composite material comprising a ceramic in combination with a metal, typically but not necessarily a sintered metal, and typically exhibiting a high resistance to temperature, corrosion, and abrasion.

The term “tailgas” refers to the exhaust flow exiting the system from the inner electrode chamber, outer electrode chamber, or a combination thereof.

The term “porous” in the context of hollow ceramic, metal, and cermet membranes and matrices means that the material contains pores (voids). Therefore, the density of the porous material is lower than that of the theoretical density of the material. The voids in the porous membranes and matrices can be connected (i.e., channel type) or disconnected (i.e. isolated). In a porous hollow membrane or matrix, the majority of the pores are connected. To be considered porous as used herein in reference to membranes, a membrane should have a continuous porosity so as to allow for the transport of gaseous species through the membrane.

### Specifications

It is to be understood in this specification that directional terms such as bottom, top, upwards, downwards etc. are used only for convenient reference and are not to be construed as limitations to the assembly or use of the apparatus described herein.

### Hollow Electrode Electrochemical Device

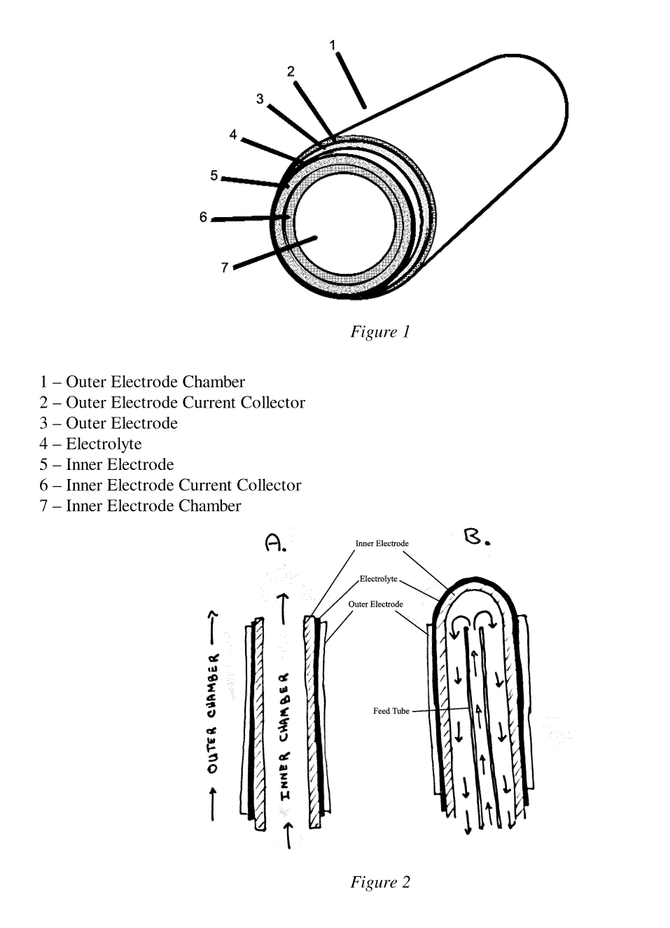

Referring to FIG. 1, the HEED is an electrochemical device comprising concentric electrode and electrolyte layers in which an inner electrode that may be either the anode or cathode contains one or more internal flow passages that may be either a hollow conduit or porous matrix having sufficient permeability to allow for flow of the reactant or product species, and in which the electrolyte layer surrounds the inner electrode, and in which the outer electrode surrounds the electrolyte layer.

Each electrode may comprise a functional layer (both not shown) and current collector that may in turn comprise multiple layers of varying structure and composition (not shown).

The electrolyte is a solid-phase oxygen ion conductor having a high ionic conductivity and low electronic conductivity. Popular electrolyte materials may include conductors of negative oxygen ions (O²⁻) such as: yttria-stabilized zirconia (YSZ), Sc-doped YSZ (ScSZ), samaria-doped ceria (SDC), gadolinium doped ceria (GDC), lanthanum-doped ceria (LDC), strontium- and magnesium-doped lanthanum gallanate (LSGM), etc.

The inner and outer electrodes are made of materials that are porous, catalytic, and possessing ionic and electronic conductivity. The composition of the electrodes is a function of the type of HEED (SOFC, SOFEC, SOEC, etc.), and of the operating mode, which determine whether the electrode is required to function in an oxidizing or reducing atmosphere, or in some cases (as in a reversible SOFC/SOFEC) in both oxidizing and reducing atmospheres.

Electrodes operating in a reducing atmosphere include SOFC anodes, SOFEC anodes, and SOEC or SOFEC cathodes where the feed gas is a mixture of steam and hydrogen. Said electrodes may comprise materials including those selected from the group: Ni-YSZ cermet, Cu-ceria cermet, nickel-iron, and ceramic materials such as La-doped SrTiO₃.

Electrodes operating in an oxidizing atmosphere include SOFC cathodes and SOEC anodes. Said electrodes may comprise materials including those selected from the group: (La, Sr)CoO₃ (LSC), (La, Sr)MnO₃ (LSM), (La, Sr)CoO₃, Fe₂O₃ (LSCF).

Electrodes operating in both oxidizing and reducing atmospheres include the SOFC cathode in a reversible SOFC/SOFEC, and the cathodes of SOEC or SOFEC where the inlet is pure steam and a the atmosphere changes from slightly oxidizing to reducing as hydrogen is generated along the length of the cell. A limited set of materials posses the requisite electronic conductivity and chemical stability in this range of atmospheres including materials selected from the group of: mixed-conducting perovskite-type oxide systems, (La, Sr)MnO₃ (LSM), (La, Sr)CrO₃ (LSCr), and (La, Sr)(Cr, Mn)O₃ (LSCM), and precious metals including silver, gold, platinum and palladium.

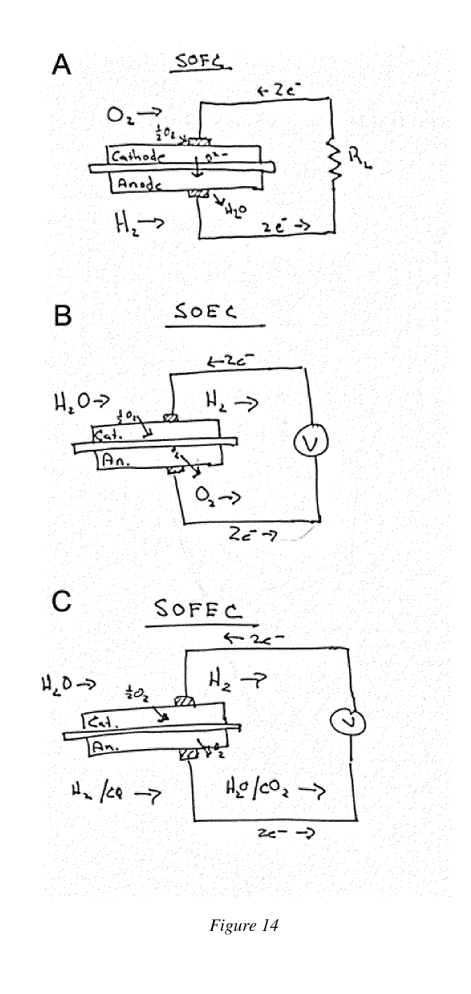

Referring to FIG. 14A, the HEED may comprise a SOFC in which an oxidant is fed to the cathode chamber and a fuel is fed to the anode chamber such that the fuel is oxidized and electricity is provided to an external electronic load. The oxidant may be pure oxygen, or a dilute oxygen mixture such as air drawn from the ambient surroundings. At the anode, hydrogen, carbon monoxide can be oxidized directly and certain light hydrocarbons and other fuel sources can be indirectly oxidized by way of side reactions that produce species that may be directly oxidized.

Referring to FIG. 14B, the HEED may comprise a SOEC in which steam is fed to the cathode chamber and an external voltage is applied to split the steam into hydrogen and oxygen ions that are transported across the electrolyte forming oxygen in combination with electrons from an external circuit.

Referring to FIG. 14C, the HEED may comprise a SOFEC in which steam is fed to the cathode chamber, and a fuel is fed to the anode chamber, and an external voltage is applied to split the steam into hydrogen and oxygen ions that are transported across the electrolyte and combined with electrons from an external circuit to oxidize fuel at the anode and where the chemical potential from this oxidation reaction reduces the electrical input required to produce hydrogen. At the anode, hydrogen, carbon monoxide can be oxidized directly and certain light hydrocarbons and other fuel sources can be indirectly oxidized by way of side reactions that produce species that may be directly oxidized.

Referring to FIG. 2A, the HEED may have two open ends and operate such that one opening is the inlet to the inner chamber and the other end is the outlet of the inner chamber.

Referring to FIG. 2B, the HEED may have a single open end and may be assembled with a gas tube or tubes contained within the inner chamber or chambers such that flow to the inner chamber enters and exits at one end of the cell and flow passes along the length of the inner electrode.

Referring to 21A, the HEED may comprise (1) a single open chamber, (2) inner electrode, (3) electrolyte, and (4) outer electrode where the geometry of the HEED is an elongated cylindrical tube.

Referring to 21B, the HEED may comprise (5) a single open chamber, (6) inner electrode, (7) electrolyte, and (8) outer electrode where the geometry of the HEED is a flattened, rectangular, or other non-cylindrical geometry.

Referring to 21C, the HEED may comprise (9) two or more inner electrode chambers, (2) inner electrode, (3) electrolyte, and (4) outer electrode where the geometry of the heed is a flattened, rectangular, or other non-circular geometry.

Referring to 21D, the HEED may comprise (1) an inner chamber comprising a porous medium having sufficient open connected porosity to allow for flow of the inner chamber fluid to and or from the electrode/electrolyte interface, (2) inner electrode, (3) electrolyte, and (4) outer electrode.

### Primary Header Plate

In an aspect, the primary header plate is an electrically insulating ceramic, glass, or glass-ceramic material, having sufficient mechanical robustness to provide mechanical support to the cells, being impermeable to gas diffusion, having chemical compatibility with the seal materials and other system components, having a thermal expansion that is compatible with the seal and HEED materials as well as with the materials of the manifold cap. Alternatively, the header plate can be an electrically conductive material such as metal, along with an insulating barrier prevents electrical contact with the HEED electrodes or interconnect components. This barrier may comprise an simulating coating, standoff, or may be provided by the gas seal.

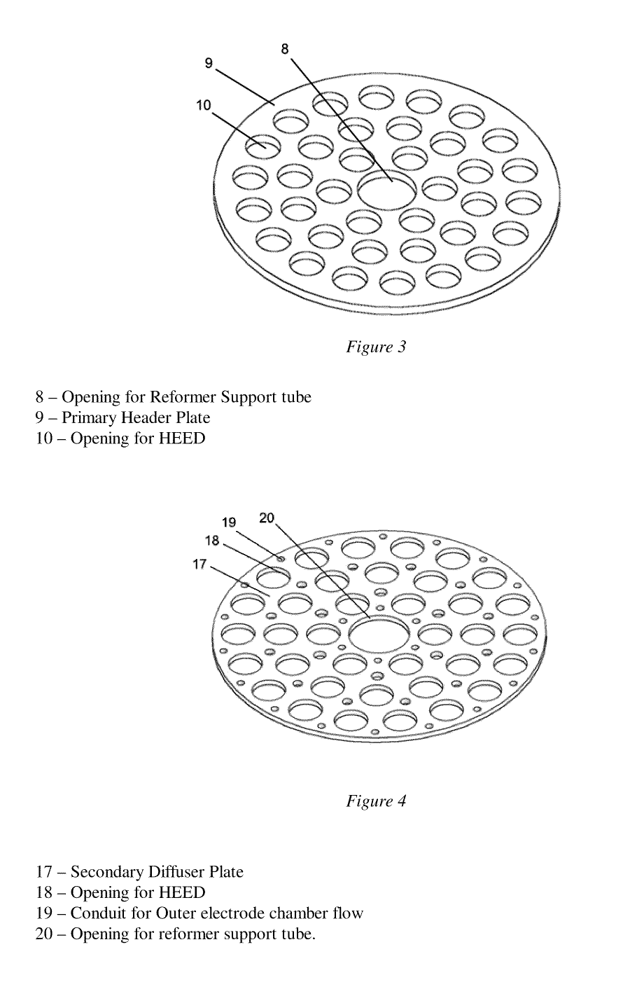

Referring to FIG. 3, one embodiment of an aspect, is a primary header plate formed from Macor®, a commercially available, machinable glass ceramic that can be cut using conventional milling, water jet machining or other methods known to those skilled in the art. The header plate has a thickness of 0.1-10 mm, and includes openings for the HEED array, and may include additional openings for inlet or outlet tubes, reformer support tubes, and feedthroughs for power leads to the interconnect assembly, instrumentation such as thermocouples, or other devices such as igniters for a fuel reformer or tailgas combustor.

### Secondary Header Plate

In an aspect, the secondary header plate is an electrically insulating ceramic, glass, or glass-ceramic material, having sufficient mechanical robustness to provide mechanical support to the cells, being impermeable to gas diffusion, having chemical compatibility with the seal materials and other system components, having a thermal expansion that is compatible with the seal and HEED materials as well as with the materials of the manifold cap. Alternatively the header plate can be an electrically conductive material such as metal, as long as an insulating barrier prevents electrical contact with the HEED electrodes or interconnect components. The secondary header plate comprises a flat structure having openings through which a length of the HEED or an extension thereof may extend such that said header plate embodies a portion of a secondary manifold chamber. The secondary header may comprise one or more additional openings providing a conduit or conduits for connecting the outer electrode chamber and the secondary manifold. The secondary header plate may be supported by a structural member attached to the primary header plate, and may function as a structural element providing lateral support to the HEED. Said lateral support may be a sliding contact allowing axial translation of the HEED relative to the secondary header plate while restricting lateral translation of the HEED relative to the secondary header plate. This configuration may impart a degree of tolerance to differential thermal expansion of HEED within the system providing a robust structure that is resistant to degradation during thermal cycling and high temperature operation.

Referring to FIG. 4, one embodiment of an aspect, is a secondary header plate formed from Macor®, a commercially available, machinable glass ceramic that can be cut using conventional milling, water jet machining or other methods known to those skilled in the art. In an aspect of this embodiment, the secondary header comprises an array of conduits interspersed between the openings for the HEED, wherein these conduits provide a fluid pathway connecting the outer electrode chamber to the secondary manifold chamber. In an alternate embodiment the openings through which the HEED extend are of a geometry that provides a gap or gaps around the HEED, wherein said gaps may function as a conduit from the outer electrode chamber to the secondary manifold.

### Diffuser Plate

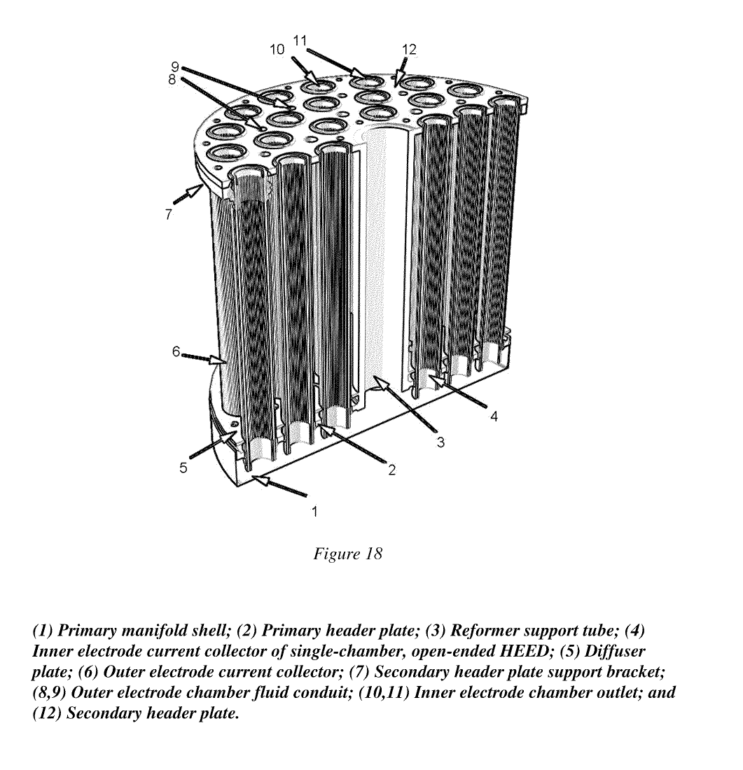

In an aspect the outer electrode chamber may contain one or more gas diffusers wherein said diffusers serve to improve the distribution of gas flow into, out of, or through the outer electrode chamber. Referring to FIG. 18, the diffuser may be a plate supported by a central reformer support tube, outer electrode manifold shell, one or more HEED, or an additional structural support member connecting said diffuser to the primary or secondary header plate. The diffuser may be a plate or sheet having openings though which the HEED extend and a pathway of the outer electrode chamber fluid that may include: a gap at the openings between the HEED and the diffuser sufficient to allow passage of gas through the chamber; additional conduits that may resemble those in the secondary header plate shown in FIG. 4; or a pathway through the diffuser plate wherein said diffuser plate comprises a porous material such as a metal foam.

The diffuser plate may comprise a material selected from the group: an electrically insulating ceramic such as alumina or magnesia; glass; glass-ceramic material; steel; or porous metal; where it is understood that if the diffuser is of an electrically conductive material the assembly must either provide a gap between the diffuser and the HEED array sufficient to prevent electrical contact, or must include an additional insulating barrier between the diffuser and the HEED array such as an insulating coating or an electrical standoff at the openings for the HEED.

### Interconnect Assembly

In an aspect the interconnect assembly is a group of electronic connections between the electrodes or current collectors of adjacent HEED.

HEED may be connected electrically in series, parallel, or series-parallel connections. In what follows the interconnect types are described as elements in a series-connected array where the interconnect forms an electronic pathway from the inner electrode or inner electrode current collector of on HEED (or an extension thereof) to the outer electrode or outer electrode current collector (or an extension thereof) of an adjacent HEED in the electrical series such that current flows through the series with minimal electronic losses in the interconnect of contact points. The interconnects are bonded to the electrodes, electrode current collectors, or extensions thereof, and may contain features for attachment to current leads, or voltage taps for monitoring system performance. The interconnect may be a separate entity or may be integral to one or more of the current collectors or extensions thereof. It is understood that the same concepts may be applied to parallel connections between cells such that parallel- or series-parallel connected arrays of HEED may be formed.

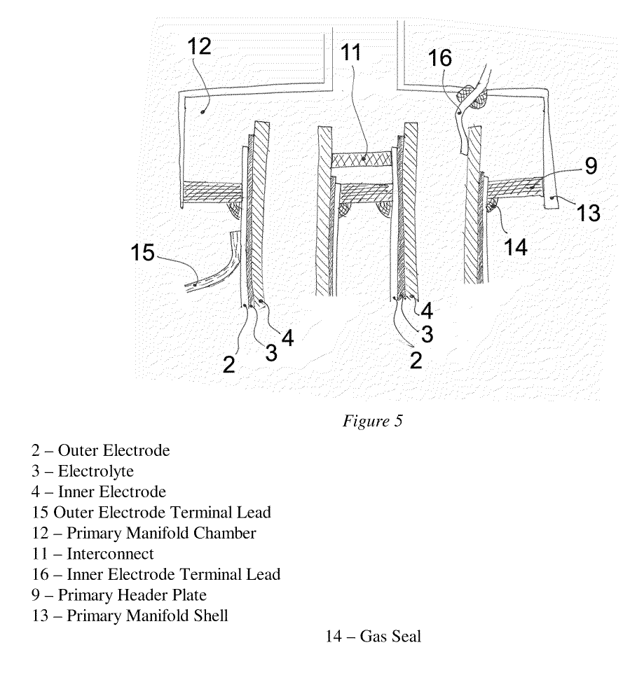

FIG. 5 shows a simplified schematic of a header assembly wherein two series-connected cells of the type shown in FIG. 7 are sealed to a primary header plate, and wherein a manifold shell is attached to said primary header plate to enclose a manifold chamber housing the electronic interconnection between the two HEED.

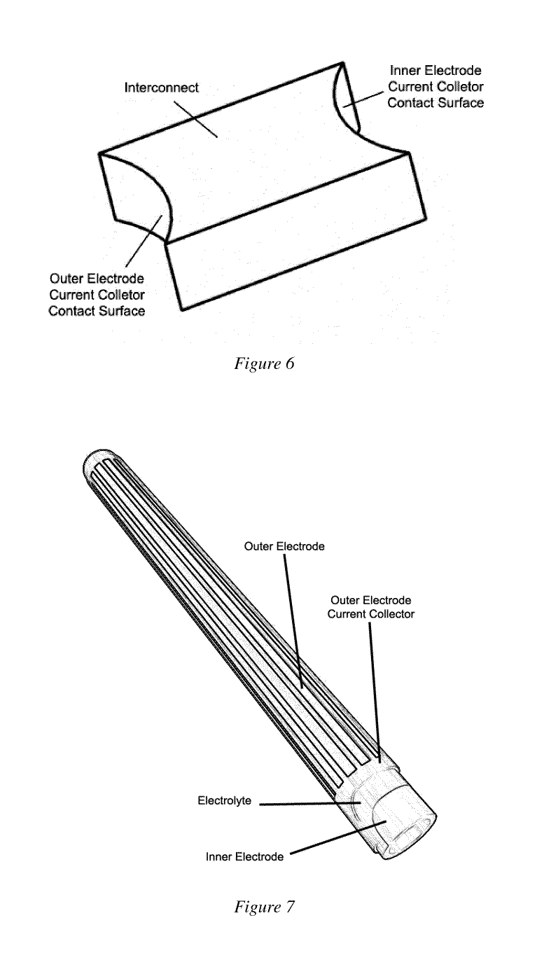

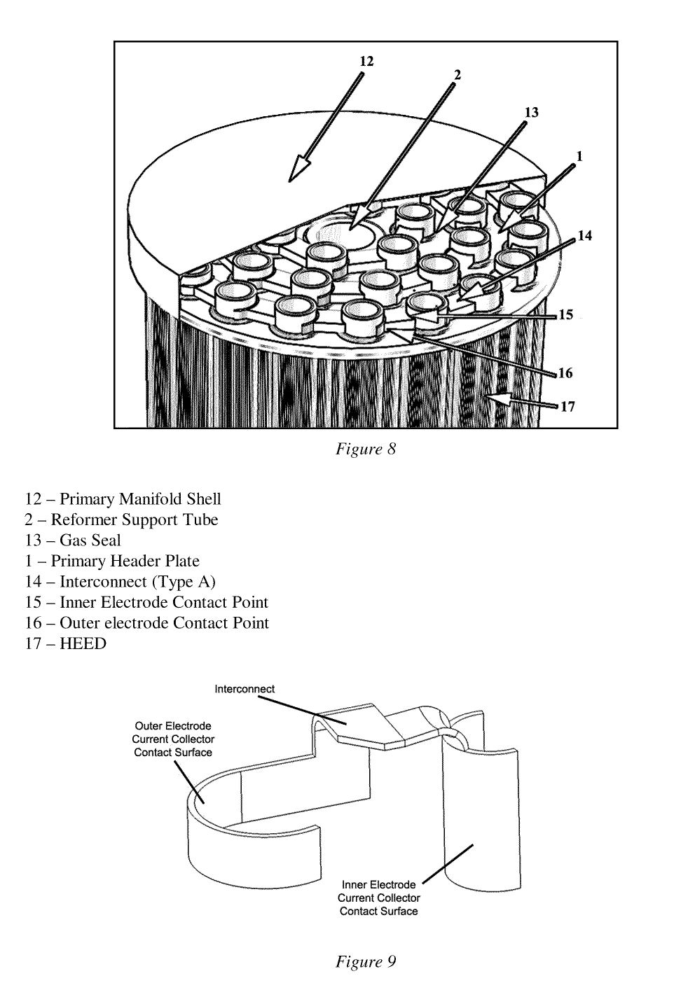

FIG. 6 shows an electronic interconnect of the type shown in FIG. 5 wherein the connection is made from the outer surface of the outer electrode, outer electrode current collector or an extension thereof to the outer surface of the inner electrode that is contacted through an exposed region of the electrolyte, outer electrode, and outer electrode current collector. The interconnect is formed from a sheet, block, or bar of metal such that at each ends the contours are shaped to fit to the contact surfaces on the HEED. The interconnect may be formed by traditional machining, stamping, blanking, laser jet cutting, water jet cutting, abrasive jet cutting, wire EDM, powder metallurgy, casting or other methods known to those skilled in the art. The interconnect material may be a conductive metal such as nickel, copper, molybdenum, silver, gold, platinum, palladium, ferritic steel, super alloy, or an electrically conductive ceramic. The interconnect may be bonded to one or more of the contact surface by diffusion bonding, welding, air brazing, furnace brazing, reactive brazing, or may be mechanically attached by a press fit assembly, bonded by compression of the bond during thermal expansion of the assembly during thermal treatment. Alternatively, referring to FIG. 11, the contact may be made wholly or in part through alternative means such as an expanding wedge forced against the contact surfaces through the action of a screw. As an example of an embodiment of an HEED system using this type of interconnect, the interconnect assembly for an HEED system comprising 36 series-connected cells is shown in FIG. 8.

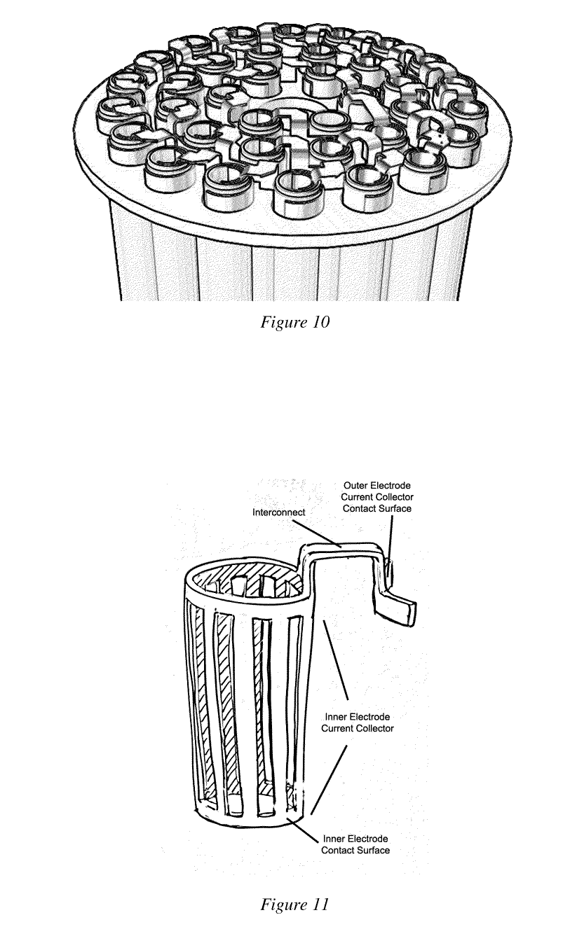

FIG. 9 shows a type of interconnect wherein the connection is made from the inner surface of the inner electrode, inner electrode current collector, or an extension thereof to the outer surface of the outer electrode, outer electrode current collector, or extension thereof of the next cell in the series. The interconnect is formed from a sheet, block, or bar of metal such that at one end can conform to the shape of the outer electrode contact surface, and the other can conform to the inner electrode contact surface. This may be a rigid or pliable solid piece, or may be a woven wire element that is tied, woven, wrapped, or otherwise bonded to the electrode or electrode current collector surfaces. The interconnect may be formed by traditional machining, stamping, blanking, laser jet cutting, water jet cutting, abrasive jet cutting, wire EDM, powder metallurgy, casting or other methods known to those skilled in the art. After cutting, the interconnect may be further formed to a complex geometry that fits the electrode contact surfaces while avoiding contact that would short circuit any HEED in the assembly. The interconnect material may be a conductive metal such as nickel, copper, molybdenum, silver, gold, platinum, palladium, ferritic steel, super alloy, or an electrically conductive ceramic. The interconnect may be bonded to one or more of the contact surface by diffusion bonding, welding, air brazing, furnace brazing, reactive brazing, or may be mechanically attached. As an example of an embodiment of an HEED system using this type of interconnect, the interconnect assembly for an HEED system comprising 36 series-connected cells is shown in FIG. 10.

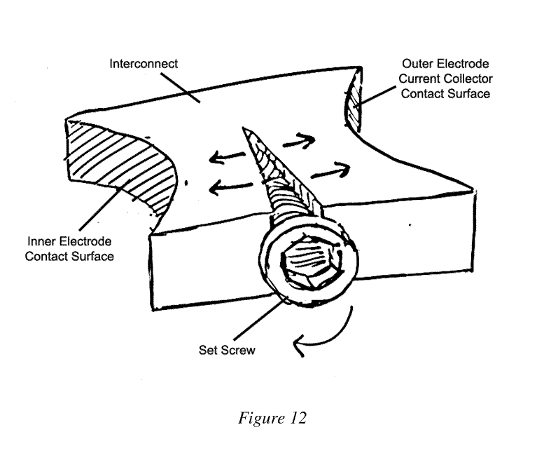

FIG. 12 shows a type of interconnect wherein the interconnect is integral to the inner electrode current collector and is cut from a malleable, conductive foil, then formed to fit within the inner electrode, contacting said electrode, or another layer of the inner electrode current collector. The interconnect extends past the length of the HEED and curves or bends around the end of said HEED and wraps around or otherwise conforms to the outer surface of the outer electrode, outer electrode current collector, or an extension thereof. The interconnect is formed from a sheet, block, or bar of metal such that at one end can conform to the shape of the outer electrode contact surface, and the other can conform to the inner electrode contact surface. This may be a rigid or pliable solid piece, or may be a woven wire element that is tied, woven, wrapped, or otherwise bonded to the electrode or electrode current collector surfaces. The interconnect may be formed by traditional machining, stamping, blanking, laser jet cutting, water jet cutting, abrasive jet cutting, wire EDM, powder metallurgy, casting or other methods known to those skilled in the art. After cutting, the interconnect may be further formed to a complex geometry that fits the electrode contact surfaces while avoiding contact that would short circuit any HEED in the assembly. The interconnect material may be a conductive metal such as nickel, copper, molybdenum, silver, gold, platinum, palladium, ferritic steel, super alloy, or an electrically conductive ceramic. The interconnect may be bonded to one or more of the contact surface by diffusion bonding, welding, air brazing, furnace brazing, reactive brazing, or may be mechanically attached

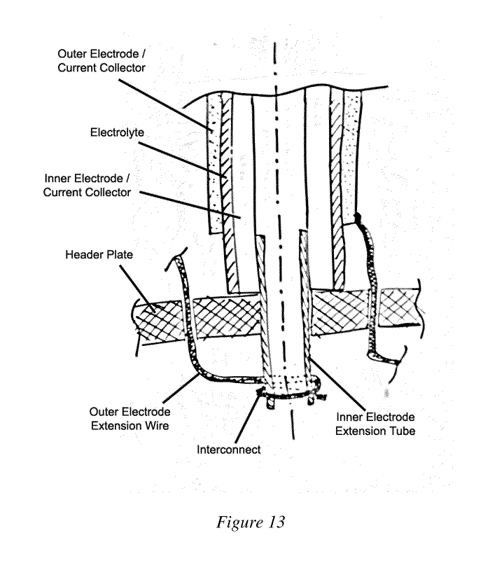

FIG. 13 shows a type of interconnect wherein the inner electrode is bonded to an extension comprising a solid, electrically conductive tube or pipe that extends past the end of the HEED providing a contact surface for the interconnect bond. In this embodiment the outer electrode current collector is bonded to a wire that passes through an opening in the primary header plate, distinct from the opening through which the HEED or an extension thereof is installed. The wire passes through the header plate and wraps around the outer surface of the inner electrode extension and is held in place either by metallic bonding, brazing, a mechanical bond from the wrapping, or a secondary tie, sleeve, or clamp. The wire may be any material that is stable and conductive in the inner and outer electrode chambers and may include a material selected from the list: nickel, copper, molybdenum, silver, gold, platinum, palladium, ferritic steel, super alloy. Additional sleeve or coating may cover the wire in order to improve the chemical or physical stability, to electrically insulate the wire from other wires, the header plate, diffuser plate(s), other HEED.

### Gas Seals

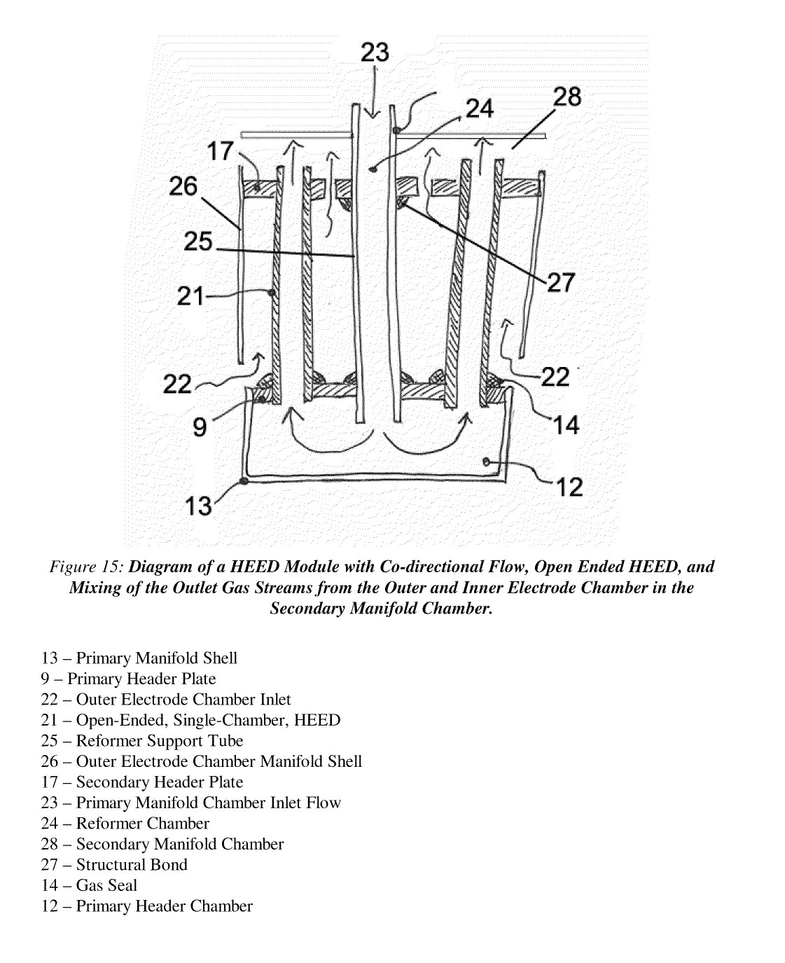

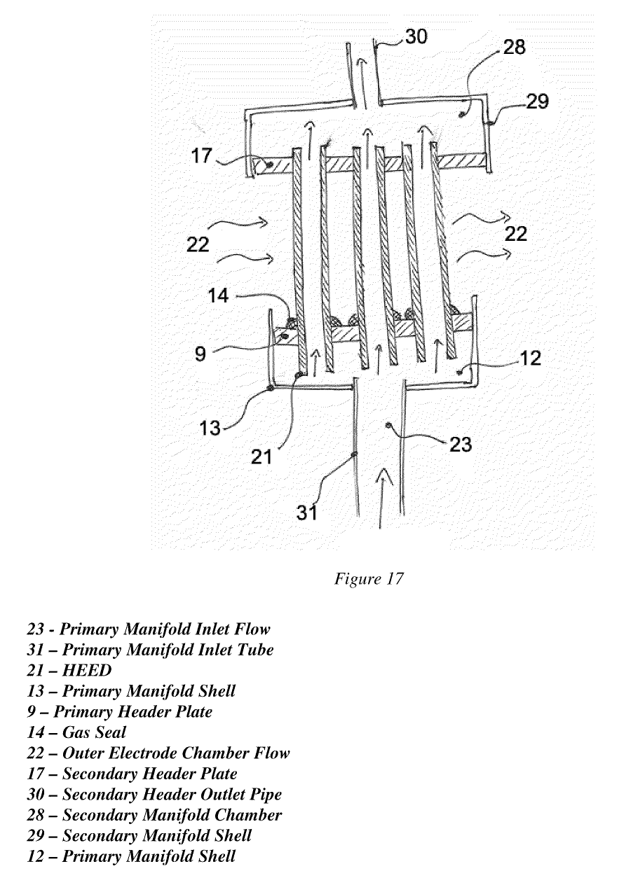

Referring to FIG. 5, FIG. 15, and FIG. 17, in an aspect the gas seals prevent intermixing of the fluids in the inner and outer electrode chambers by providing a seal at the interface of the primary header plate and the HEED or extension thereof. The seals may be bonded to any portion of the HEED such that the intermixing of gasses is restricted and such that the current collectors, interconnects, or extensions thereof are maintained in a gas environment in which they are stable. Additional seals may be present bonding the primary header plate to the primary manifold shell, and at additional feedthroughs in the primary header plate and manifold shell, or elsewhere in the system. Seals may be material selected from the list including ceramic, glass-ceramic, glass, metallic braze fillers, mica, graphite, metal foils such as copper, or nickel. The materials may be applied as a paste, frit, powder, gasket, and may have multiple constituents providing improved sealing, or providing mechanical support. At the primary header plate, the seals provide, in combination with the mechanical support of the assembly to the header plate, mechanical support against axial translation, rotation, bending, or translation. The seal materials must have a coefficient of thermal expansion that is compatible with the materials in the header assembly, the HEED array, and interconnects to allow for durability during thermal cycling.

### Reformer

If the HEED is a SOFC or SOFEC, the anode chamber will be fed by a gaseous fuel source that may include (a) directly oxidizable species, such as hydrogen and carbon monoxide; (b) species that can be internally reformed within the inner electrode chamber such as ammonia, syngas derived from coal or natural gas, light hydrocarbons such as methanol, ethanol, methane, ethane, butane, where these reactants may be injected directly, or in mixtures with steam, an oxidant or combinations thereof, and where these species may be preheated and or vaporized prior to injection into the inner electrode chamber; (c) species that are reformed, converted or otherwise modified in an additional reactor that my perform processes from the following list: in a pre-reformer that may employ steam reformation, partial oxidation, reactions that combine steam reformation and partial oxidation (including autothermal reforming processes), gasification, or other process.

Referring to FIG. 15 and FIG. 18, the system may include a reformer support tube housing said fuel reformer, and may be located central to the HEED array which may provide desirable system characteristics including: (1) even flow distribution in the inlet manifold chamber; (2) structural support for secondary header or diffuser plate; or (3) or direct heat transfer between the reformer and HEED array.

### Power Leads

In an aspect of, the power leads are electrically conductive elements attached to HEED at points that include: inner electrode, inner electrode current collector, outer electrode, outer electrode current collector, interconnect, or extensions thereof. Referring to FIG. 5, power leads are connected at terminal electrodes in each series connected group of HEED in the array, and may also be made at intermediate points in the series array to allow for variable voltage output, turndown capability, or bypass of cells or cell groups. The leads may be solid, or stranded metallic wire, strips, busses, or bars comprising a material selected from the group of: nickel, platinum, gold, silver, palladium, copper, ferritic steel, super alloys, molybdenum, or alloys of any of the preceding metals. The leads may include an additional coating, sheath, or sleeve of an additional material to improve the durability or stability of the current lead or to provide electrical insulation between the current lead and other elements in the system. The insulating sheath may be a solid or segmented sleeve, or woven from fibers. The material for the sleeve may be selected from the group: ceramics, ceramic or glass sheaths including alumina, zirconia, mullite, and Macor®.

### Outer Electrode Chamber Manifold

Referring to an aspect the outer electrode chamber of the HEED array is enclosed in a manifold shell that separates the outer electrode chamber from the inner electrode chamber, manifold chambers, reformer, tailgas combustor, or surroundings. In the case where the HEED is a SOFC, the outer manifold chamber is the cathode and the manifold supplies oxidant to the HEED array. For an SOFC array, if the oxidant is dilute oxygen (such as air) or if the oxidant is pure oxygen fed at a utilization lower than unity, the outer electrode manifold will also provide an outlet for inert and unreacted species. In the case where the HEED is a SOEC array, the outer manifold chamber will contain oxygen produced at the SOEC anode (the outer electrode) and will comprise and outlet for said oxygen. In the case where the HEED is a SOFEC, and the outer electrode is the cathode, the inlet to the outer electrode chamber will be steam or a mixture of steam and hydrogen, and the outlet will be a hydrogen-rich steam-hydrogen mixture. In the case where the HEED is a SOFEC and the outer electrode is the anode, the inlet to the outer electrode will be a gaseous fuel supply, and the outlet will be a mixture of unconverted fuel and reactant products including carbon dioxide and steam.

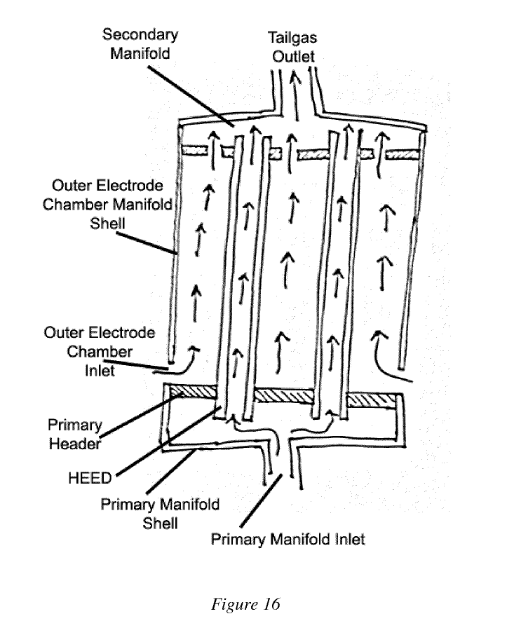

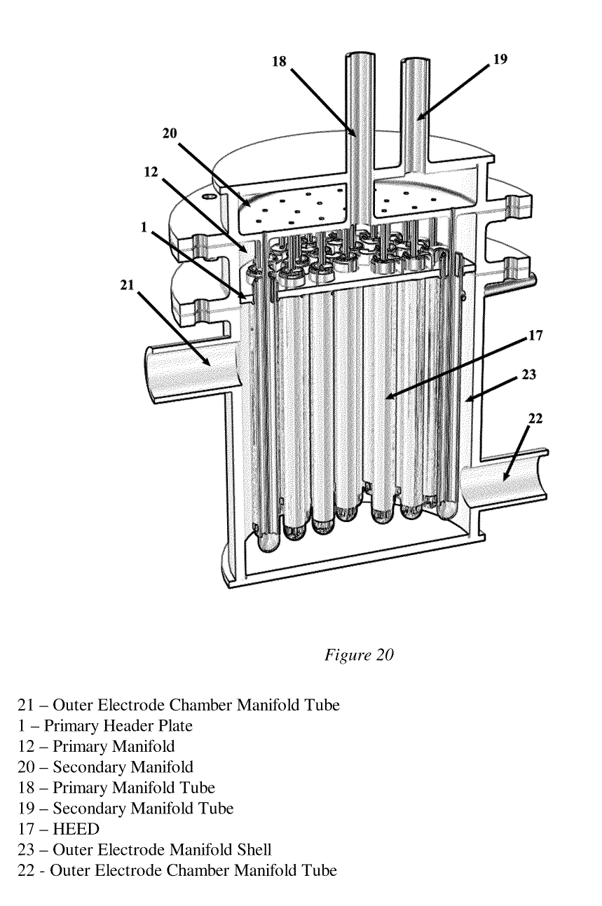

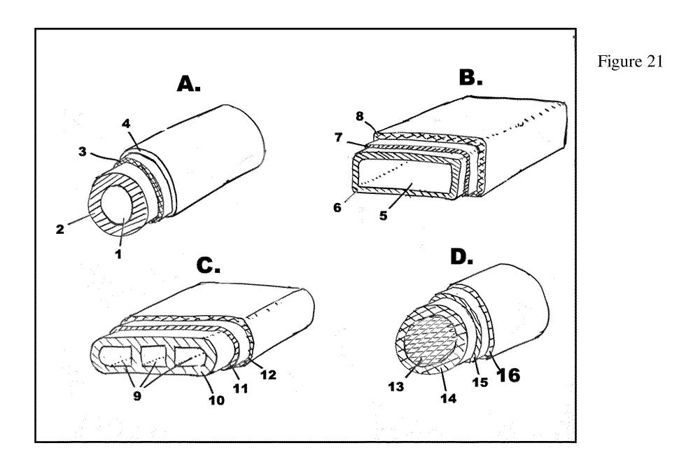

Referring to FIG. 15, FIG. 16, and FIG. 20 the manifold may be physically attached to the header assembly at either the primary or secondary header plate. Referring to FIG. 17 and FIG. 18, the manifold may be separate from the HEED header assembly, and may be comprised of a metal shell or heat exchanger, or may be part of the thermal insulation thermal insulation jacket that surrounds the HEED assembly and provides the necessary fuel conduits.

Referring to FIG. 15 and FIG. 16, and FIG. 18 fluid flow may enter the outer electrode chamber near the primary header plate and flow parallel to the inner electrode chamber flow, pass through conduits in the secondary header plate and mix with the inner electrode flow in the secondary manifold chamber. This configuration may be useful for SOFC systems where mixing of the tailgas will result in combustion of the unreacted fuel to provide heat for the system or to reduce undesirable emissions from the effluent gasses.

Referring to FIG. 17 and FIG. 20, fluid flow may enter the outer electrode chamber from an external manifold, flow perpendicular to the flow in the inner electrode chamber, and exit the outer electrode chamber through the external manifold. This configuration may be useful for electrolyzer systems where the hydrogen produced in the anode chamber must be kept separate from the cathode chamber, in SOFC systems where uncontrolled combustion of the tailgas is undesirable, or in a system where minimizing the pressure drop across the outer electrode chamber is desirable.

### EXAMPLES

### Example I

### Compact Solid Oxide Fuel Cell Module for Portable Power Applications

This example is an embodiment for fabrication of a power generator for portable applications. This example illustrates a specific type of HEED of the type shown in FIG. 1. The cell has two open ends as shown in FIG. 2A, and is a solid oxide fuel cell operated as shown in FIG. 14A. This example illustrates a specific anode-supported cell construction of a cylindrical cell geometry having a single inner electrode chamber such as the cells in as shown in 21A. This example intended to only be illustrative and it is understood that it is within the skill of a practitioner to also construct cathode-supported cell, electrolyte supported cell, as well as other cell geometries including multi-chamber or non-cylindrical cells, or other suitable cell constructions.

A solid oxide fuel cell system is constructed comprising an array of hollow electrode solid oxide fuel cells (SOFC) where the SOFC are tubular having a cylindrical geometry, where the anode is the inner electrode and is the mechanical support for the cell. The SOFC comprises the following layers having a concentric arrangement: (a) the inner electrode that is an anode comprising a Ni-YSZ cermet having a porosity of 40-70% such that the nickel is a continuous matrix having a high electrical conductivity, and having a thickness of 0.1 to 10 mm, functioning as the mechanical support for the cell; (b) an anode functional layer having a finely structured Ni-YSZ cermet having a continuous nickel phase and a high content of YSZ; (c) a dense, thin film electrolyte comprising 8-YSZ with a thickness of 1-100 micron; (d) a cathode functional layer comprising a finely structured composite of YSZ and Sr-doped lanthanum manganate (LSM); (e) a cathode current collector comprising a porous Sr-doped lanthanum cobaltite (LSC). To provide additional axial conductance, additional current collector layers of metal are bonded to the inner and outer electrode.

On the inner electrode (anode) side the additional current collector is a woven wire gauze comprising nickel or copper and is bonded to the Ni-YSZ cermet anode support. The bond may be: (a) a diffusion bond between the additional current collector and the electrode, which may be augmented by the addition of a fine copper or nickel powder to improve the diffusion bonding, or a metallurgical bond may be formed with a metallic braze filler, such as a silver-copper braze, Ni—Cr braze, gold braze, palladium braze, or other suitable material where the liquidus temperature of the braze is at least 25-100 degrees Celsius above the operating temperature of the SOFC.

On the outer electrode (anode) side the additional current collector is a woven wire gauze comprising silver or stainless steel and is bonded to the cathode current collector. The bond may be: (a) a diffusion bond between the additional current collector and the electrode, which may be augmented the addition of a fine silver or other metal powder to improve the diffusion bonding, or a metallurgical bond may be formed with a metallic braze filler, such as a silver-copper braze, Ni—Cr braze, gold braze, palladium braze, or other suitable material where the liquidus temperature of the braze is at least 25-100° C. above the operating temperature of the SOFC.

The SOFC are assembled to a primary header plate as shown in FIG. 18, where the primary header plate is similar to that shown in FIG. 3, and is machined from a plate of Macor®, a commercially available machinable glass-ceramic having a coefficient of thermal expansion that is relatively close to that of the Ni-YSZ cermet anode support. The SOFC are assembled such that a length of the cell and current collectors extends through the primary header plate a length of 1-50 mm. The primary manifold chamber is formed from stainless steel foil, and is the inlet manifold to the anode (inner electrode) chamber of the SOFC array. The cells are series connected as shown in FIG. 8 or FIG. 10.

The inlet manifold is fed by fuel reformer that is housed in an alumina reformer support tube central to the SOFC array. The fuel reformer is a partial oxidation reactor that converts a mixture of vaporized diesel fuel and air to a fuel gas comprising carbon monoxide, hydrogen, nitrogen, and other gasses that can be fed directly into the anode of the SOFC array.

A machined Macor® diffuser plate is supported by the reformer support tube, and is offset from the primary header plate such that the gap between the diffuser and primary header plates is the inlet for the cathode (outer electrode) chamber flow.

A secondary header plate similar to that shown in FIG. 4 is supported by the reformer support tube at the outlet end of the SOFC array. The SOFC extend into openings in this secondary header plate, and the sliding contact allows for axial translation of the SOFC relative to the secondary header to allow for thermal expansion of the SOFC. Conduits in the secondary header plate or gaps at the openings where the SOFC pass through the secondary header plate allow for flow of the effluent from the cathode (outer electrode) chamber to pass through the secondary header plate where it mixes with the effluent from the anode (inner electrode) chamber.

A secondary manifold shell is assembled to the secondary header plate as in FIG. 16, and may house a catalyst and or an igniter to promote complete combustion of the tailgas. The hot tailgas may exit the system directly, or may enter external system components including vaporizers or preheaters for the fuel stream, or a preheater for the incoming air.

A manifold shell is external to the header assembly, and is formed by cylindrical shells of steel foil or insulation layers that form a heat exchanger to preheat the incoming air and direct it to the inlet of the cathode chamber.

Power leads are connected at terminal ends of the series array. The anode power lead is a braided platinum wire that is connected to the wire gauze of the terminal anode current collector. The anode lead is insulated within the interconnect chamber by a segmented sleeve of alumina, passes through an opening in the primary header plate, and is routed through the external manifold out of the system hot zone. The cathode power lead is a solid silver wire that is connected to the wire gauze on the cathode terminal cell, attached with a Nichrome™ wire wrap. The cathode lead is insulated with a braded ceramic fiber sleeve and is routed through the external manifold out of the system hot zone.

Alumina-magnesia based ceramic cement is used to bond the reformer support tube to the diffuser plate, primary header plate, and secondary header plate, and to form the gas seals between the primary header plate and the SOFC, reformer support tube, and primary manifold shell.

The secondary header plate attaches to a support ring or bracket that mounts to a manifold assembly comprising a tailgas combustor that integrates with the secondary manifold chamber and a heat exchanger that surrounds the cathode (outer electrode) chamber and preheats the cathode air entering the system with heat from the combusted tailgas. The entire assembly is seated in a cylindrical insulation shell that allows it to operate at 750-850° C. with minimal conductive losses through the insulation jacket.

### Example II

### Prototype SOFC Power Module and Test Thereof

In this example, a SOFC power module was constructed similar to that described in Example I, as illustrated in FIG. 18, and having an interconnect assembly similar to that illustrated in FIG. 10 wherein the interconnect material is copper, and the bond between said interconnect and the anode and cathode current collectors is formed using a palladium-copper-silver braze filler material.

The SOFC were anode-supported solid oxide fuel cells, wherein the oxygen ion conduction material was yttria-stabilized zirconia (YSZ), the electronically conducting material in the anode layer was nickel, and the electronically conducting catalyst in the cathode layer was a composite of strontium-doped lanthanum manganite (LSM) and strontium-doped lanthanum cobaltite (LSC). The inner electrode current collector was a woven wire mesh of copper, bonded to the inner electrode through a combination of diffusion bonding aided by the addition of a coating of very fine copper powder, and a metallurgical bond formed with a gold based braze filler material. The outer electrode current collector was a woven mesh of silver wire, wrapped around the outer electrode surface, fastened with Nichrome wire ties, with electrical contact through a diffusion bond, aided by the addition of a fine silver powder coating applied to the mesh.

The cell fabrication techniques, and the composition and structure of the cell materials are well known to those skilled in the art. The cells were made with an active area (cathode surface area) of approximately 24.5 cm². The thickness of each cell was about 0.35 inches (0.9 mm). The entire cell was about 10 cm in length and 1 cm diameter. The system contained 36 SOFC, forming a cylindrical bundle with a volume of approximately 1 liter, and having a total active area of 914.4 cm².

The system was tested in an electrically heated furnace in which air was supplied by six pipes directing flow to the base of the cathode chamber, just above the primary header plate. Fuel was fed from a pipe cemented to the reformer support tube. Both fuel and air were heated in the inlet piping, to a temperature of 600-750° C. at the inlet to the SOFC. The furnace temperature was held at 790° C., and the unreacted fuel and air were allowed to mix and burn above the secondary header plate.

The fuel was a mixture of 42% hydrogen, with a balance of nitrogen to approximate the fuel content of a reformate mixture produced from the catalytic partial oxidation of JP-8 diesel fuel. The oxidant was air from the ambient surroundings at a pressure of ˜94 kPA. The flow rate of fuel and oxidant were fixed during the test at a level that would yield approximately 40% utilization of fuel and oxidant at a system current of 12 A. Flow was controlled and measured using a MKS® mass flow controller, calibrated for the gas mixture and operating temperature. The polarization characteristics were measured using an Agilant® electronically controlled variable resistive load. The electronic current was measured independently using a precision shunt resistor and Keithly® multimeter. The voltage was measured using four probe readings with a Keithly® multimeter.

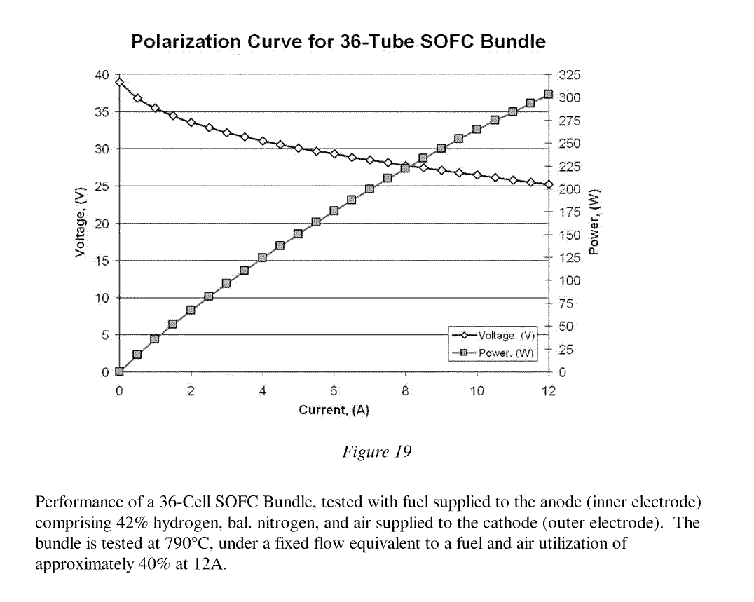

The performance results for the prototype system are presented in FIG. 19, showing the polarization response of the system over a range of 0-12 A. The peak power output is ˜303 W at 25.4, equivalent to an average area specific power density of 332 mW/cm² at 0.7V/cell. This level of performance is high compared to competing technologies for portable power generation.

### Example III

### Fuel-Assisted Electrolysis Module for Hydrogen Generation from Hydrocarbon Fuels

This example is an embodiment wherein the HEED are solid oxide fuel-assisted electrolysis cells (SOFEC) operating as shown in FIG. 14C, and having a single-chamber, cylindrical geometry with a single open end and feed tube in the inner electrode chamber similar to the cell shown in FIG. 2.

The cells are cathode supported SOFEC, wherein the electrolyte is Sm-doped ceria (SDC) having a thickness of 8-20 micron, the cathode is the inner electrode and comprises a porous Cu-SDC cermet having a thickness of ˜1 mm, and the anode is the outer electrode comprising a Cu-SDC cermet and having a thickness of 0.5 mm.

A system of SOFEC is assembled similar to that shown in FIG. 20, wherein the SOFC are assembled to a primary header plate comprising a machined Macor plate having a thickness of 5-10 mm, that is seated in a stainless steel manifold shell such that the outer electrode (anode) flow is approximately perpendicular to that of the inner electrode chamber, and wherein the inner electrode flow is fed to each cell through a feed pipe that passes through the primary manifold chamber and is fed by a secondary manifold. The inlet flow to the cathode is steam with a small fraction of hydrogen such that the entire length of the cathode chamber is in a chemically reducing atmosphere, where the copper in the cathode is stable and conductive. In the anode chamber, the feed gas is a gaseous fuel derived from fuel source that may include a fuel from the croup: (1) a hydrocarbon such as diesel, gasoline, kerosene, methane, (2) coal derived syngas comprising hydrogen and carbon monoxide along with other inert species and impurities; (3) biofuel such as ethanol, methanol, or biodeisel; or (4) gaseous products from a gasifier operating on carbonaceous feedstocks.

The electronic interconnection is of the type shown in FIG. 8, where the interconnects are copper and are held in place by a metallurgical bond.

The system is heated externally by a source that may include: combustion of the unspent anode fuel, electric heat, solar thermal, or integration with another power cycle.

The hydrogen produce at the cathode exits the system and enters a condenser where it is separated from the steam in the flow, and then may be compressed for distribution or storage. A portion of the hydrogen is recycled back to the cathode inlet flow.

This embodiment allows for a compact unit capable of producing pure hydrogen from a variety of fuel sources wherein said hydrogen is of purity suitable for use in PEM fuel cell vehicles or other applications requiring very low levels of CO and other impurities. The practitioner is skilled in the art of producing SOFEC in a variety of geometries, material, and sizes and a system of this type could be readily constructed by those skilled in the art.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

What is claimed is:

1. An electrochemical system comprising:
(a) a plurality of hollow electrode electrochemical devices (HEED) having an inner electrode chamber;
(b) a primary header plate mechanically supporting the array of HEED, with gas seals connecting the heed array to the primary header plate;
(c) a primary manifold with a chamber connected to the primary header plate,
the primary header plate forming a portion of the primary manifold to the inner electrode chamber of the HEED;
(e) one or more electronic interconnects between the electrochemical devices of the HEED where said interconnects are metallic and located within the primary manifold chamber;
(f) a manifold structure for flow within the outer electrode chamber;
(g) electronic leads connecting the HEED array to an external circuit.

2. The electrochemical system of claim 1 comprising additional elements that may provide mechanical support, conduits for flow entering or exiting the system, improvements in even distribution of flow throughout the system.

3. The electrochemical system of claim 1 wherein the hollow electrode electrochemical devices comprises an inner electrode, solid-phase electrolyte, and outer electrode where the inner and outer electrodes are each in contact with an inner and outer electrode chamber, where the electrodes are configured to allow the transport of gaseous reactants or products between the electrode chamber and the electrode-electrolyte interface.

4. The electrochemical system of claim 1 wherein the HEED is:
(a) a solid oxide fuel cell (SOFC) wherein the inner electrode chamber is supplied a gaseous fuel, the inner electrode is the anode, the electrolyte is a conductor of negative oxygen ions, the outer electrode is the cathode, and the outer electrode chamber is fed an oxidant; or
(b) a solid oxide electrolysis cell (SOEC) wherein the inner electrode chamber is fed steam or a mixture of steam and hydrogen, the inner electrode is the cathode, the electrolyte is a solid-phase conductor of negative oxygen ions, the outer electrode is the anode, and oxygen is produced in the outer electrode chamber; or
(c) a solid oxide fuel-assisted electrolysis cell (SOFEC) wherein the anode may be either the inner or outer electrode, the anode chamber is supplied a gaseous fuel, the electrolyte is a solid-phase conductor of oxygen ions, the cathode chamber is supplied steam or a mixture of steam and hydrogen; or
(d) a cell configured such that it can be operated in two or more of modes described above, such that the inner electrode chamber contains a reducing gas atmosphere, and such that the materials used in the inner and outer electrodes and the inner and outer electrode current collectors are stable and electrically conductive in the operating environments to which they are exposed; or
(e) an ion transport membrane having a solid electrolyte and operating such that the inner electrode chamber contains a reducing gas atmosphere, and such that the materials used in the inner and outer electrodes and the inner and outer electrode current collectors are stable and electrically conductive in the operating environments to which they are exposed.

5. The electrochemical system of claim 1 wherein the HEED further comprises a porous electrically conductive current collector located within the inner chamber of the HEED, electrically coupled to its inner electrode layer, and having sufficient porosity to enable the flow of reactant and or product fluid between the inner electrode chamber and the inner electrode layer.

6. The electrochemical system of claim 1 wherein the HEED further comprises a porous electrically conductive current collector located within the outer chamber of the HEED, electrically coupled to its outer electrode layer, and having sufficient porosity to enable the flow of reactant and or product fluid between the outer electrode chamber and the outer electrode layer.

7. The electrochemical system of claim 1 wherein the current collector is an expanded metal foam, electrically conductive cermet, a solid or braided metal wire, a wire mesh or wire gauze, expanded metal foil, porous ceramic, or perforated metal foil or tube.

8. The electrochemical system of claim 1 wherein the inner electrode is a porous electronic conductor or a mixed ionic and electronic conductor having sufficient porosity (10-90%) to allow for gas transport between the inner electrode chamber and the interface between the inner electrode and the electrolyte surface, and having sufficient electronic conductivity to minimize ohmic losses in the flow of electrons between the inner electrode current collector and the interface between the inner electrode and the electrolyte surface.

9. The electrochemical system of claim 1 wherein the outer electrode is a porous electronic conductor or a mixed ionic and electronic conductor having sufficient porosity (10-90%) to allow for gas transport between the outer electrode chamber and the interface between the outer electrode and the electrolyte surface, and having sufficient electronic conductivity to minimize ohmic losses in the flow of electrons between the outer electrode current collector and the interface between the outer electrode and the electrolyte surface.

10. The electrochemical system of claim 1 wherein the outer electrode current collector composition includes a material selected from the group: strontium-doped lanthanum manganate (LSM), strontium-doped lanthanum cobaltite (LSC), strontium-doped lanthanum chromite (LSCr), (LSCM), (LSCr), Ni-YSZ cermet, Ni-ScSZ cermet, Ni-SDC cermet, Ni-GDC cermet, Cu-YSZ cermet, Cu-ScSZ cermet, Cu-SDC cermet, Cu-GDC cermet, silver and its alloys, super alloys such as Inconel®625, Haynes®230, Crofer®22, copper and its alloys, nickel and its alloys, molybdenum and its alloys, iron and its alloys, stainless steels such as SS430, where any of the preceding materials may be coated with an electronically conductive layer to improve the stability in the operating environment or to provide improved contact between the current collector and electrode surface.

11. The electrochemical system of claim 1 wherein the inner electrode current collector composition includes a material selected from the group: strontium-doped lanthanum chromite (LSCr), (LSCM), (LSCr), Ni-YSZ cermet, Ni-ScSZ cermet, Ni-SDC cermet, Ni-GDC cermet, Cu-YSZ cermet, Cu-ScSZ cermet, Cu-SDC cermet, Cu-GDC cermet, silver and its alloys, super alloys such as Inconel®625, Haynes®230, Crofer®22, copper and its alloys, nickel and its alloys, molybdenum and its alloys, iron and its alloys, stainless steels such as SS430, where any of the preceding materials may be coated with an electronically conductive layer to improve the stability in the operating environment or to provide improved contact between the current collector and electrode surface.

12. The electrochemical system of claim 1 wherein the primary header plate is a sheet of a rigid material having mechanical strength sufficient to provide structural support for the array of HEED, contains openings for HEED or extensions thereof, and may contain additional openings for elements including: (a) conduit for fluid flow into or out of the primary manifold; (b) structural member connecting the primary header plate to other elements including one or more diffuser plates, the secondary header plate, outer electrode chamber manifold, primary manifold, or mounting bracket for connection to external hardware; (c) feedthroughs for electrical wires including terminal and intermediate electrical connections to the HEED array; (d) feedthroughs for instrumentation including thermocouples imbedded in the inner electrode chamber, manifolds connected to the inner electrode chamber, feed piping, or connected fuel reformer; (e) other hardware imbedded in the system including igniters for a tailgas combustor or fuel reformer; (f) features for improving alignment or facilitating assembly or fabrication of the system or primary header plate.

13. The electrochemical system of claim 1 wherein the primary header plate includes a material selected from the group of: (a) ceramics including alumina, magnesia or combinations thereof; (b) machinable glass ceramics including Macor; (c) stainless steels including SS430, SS316, SS304; (d) glass.

14. The electrochemical system of claim 1 wherein the primary header includes further one or more elements selected from the group of: (a) coating to provide improved chemical or physical stability, coating to prove an electrically insulting layer between the header plate and either the HEED array or elements from the interconnect assembly, or restrict the diffusion of gasses through the primary header plate; (b) standoffs to provide an electrically insulating barrier between the primary header plate and the HEED or interconnect assembly, or to provide an improved surface for sealing to the HEED.

15. The electrochemical system of claim 1 wherein the secondary header plate is a sheet of a rigid material having mechanical strength sufficient to provide lateral support for the array of HEED, contains openings for HEED or extensions thereof, and may contain additional openings for elements including: (a) conduits for fluid flow connecting the secondary manifold to the outer electrode chamber; (b) conduit for fluid flow into or out of the secondary manifold; (b) structural member connecting the secondary header plate to other elements selected from the group: one or more diffuser plates, the primary header plate, outer electrode chamber manifold, secondary manifold, or mounting bracket for connection to external hardware; (c) feedthroughs for electrical wires including terminal and intermediate electrical connections to the HEED array; (d) feedthroughs for instrumentation including thermocouples imbedded in the inner electrode chamber, manifolds connected to the inner electrode chamber, outer electrode chamber, manifolds connected to the outer electrode chamber, feed piping, or connected fuel reformer; (e) other hardware imbedded in the system including igniters for a tailgas combustor or fuel reformer; (f) features for improving alignment or facilitating assembly or fabrication of the system or primary header plate.

16. The electrochemical system of claim 1 wherein the secondary header plate includes a material selected from the group of: (a) ceramics including alumina, magnesia or combinations thereof; (b) machinable glass ceramics including Macor; (c) stainless steels including SS430, SS316, SS304; (d) glass.

17. The electrochemical system of claim 1 wherein t secondary header further includes one or more elements selected from the group of: (a) coating to provide improved chemical or physical stability, coating to prove an electrically insulting layer between the header plate and the HEED array, or restrict the diffusion of gasses through the primary header plate; (b) standoffs to provide an electrically insulating barrier between the primary header plate and the HEED array.

18. The electrochemical system of claim 1 additionally comprising a diffuser plate, wherein the diffuser plate is a sheet of rigid material located in the outer electrode chamber having features including: openings through which the HEED extend, conduits allowing the flow of product or reactant species through the outer electrode chamber while improving the even distribution of said flow throughout the chamber, additional openings to allow for instrumentation, electrical leads, structural support members, connection to mounting brackets, or feedthroughs for other hardware including igniters for combustors or fuel reformers.

19. The electrochemical system of claim 1 wherein the gas seals join the HEED to the primary header plate such that: the HEED are mechanically constrained with regard to axial, lateral, and rotational translation; gas flow or diffusion through the gap between the HEED and header plate is restricted; HEED are electrically isolated from the primary header plate and from contact from other HEED within the array except as-intended by the design of the interconnect assembly.

20. The electrochemical system of claim 1 wherein the gas seals have a composition that includes one or more materials selected from the group of: ceramic cements including alumina, magnesia, zirconia, ceria or combinations thereof; glasses including borosilicate and aluminosilicate; glazes including lead oxide based and other; braze filler materials including silver and its alloys, gold and its alloys, palladium and its alloys, copper and its alloys, tin and its alloys, nickel and its alloys; reactive metal brazes from bonding ceramics to metals or other ceramics; compressive seals including mica or graphite, that may exist in combination with one or more additional material to wet the sealing surfaces and reduce interfacial leakage.

21. The electrochemical system of claim 1 wherein the primary manifold is a shell surrounding the outer face of the primary header plate, and sealed to the primary header plate, and enclosing a chamber that may be: (a) an inlet manifold from which reactant fluid flows into the inner chamber of the HEED array; or (b) an outlet manifold from which product and unconverted reactant flow from the inner chamber of the HEED.

22. The electrochemical system of claim 1 wherein the primary manifold has an the inlet manifold to the inner electrode chamber that supplies reactants to the inner electrode chamber, and functions as a connection to a conduit for fluid flow to or from the manifold chamber to either a reactant supply, that may include a fuel reformer, gas m

23. The electrochemical system of claim 21 wherein the inlet manifold has a fuel source that is a reformer for converting a fuel that may include a hydrocarbon selected from the group of: methanol, ethanol, kerosene, diesel, JP-8, JP-10, wax, corn oil, kerosene, gasoline, syngas, methane, ethane, butane, hexane, and ammonia.

24. An electrochemical system comprising:
(a) an array comprising a plurality of hollow electrode electrochemical devices (HEED);
(b) a primary header plate mechanical supporting the array of HEED,
(c) a primary manifold connected to the primary header plate, which together with the primary header plate (b) forms an primary manifold inner electrode chamber of said HEED;
(d) gas seals connecting the HEED array to the primary header plate;
(e) one or more metallic electronic interconnects between HEED and located within the primary manifold chamber;
(f) an outer manifold structure to provide an outer electrode chamber and configured to allow flow within the outer electrode chamber;
(g) electronic leads connecting the HEED array to an external circuit.

25. The system of claim 23 additionally comprising (h) additional elements that provide any one or more of mechanical support, conduits for flow entering or exiting the system, improvements in even distribution of flow throughout the system.

26. An electrochemical system comprising:
hollow electrode electrochemical devices (HEED) in electrical series where the HEED are in a parallel array;
a primary inner manifold a first end of the array that provides a chamber constructed for a flow into the interior of the devices and provide a reducing atmosphere,
an interconnect structure comprising connection of the HEED is a series connection where an anode current collector is connected to a first device at the first end of the bundle, a cathode current collector is connected to a second device adjacent or in proximity to the first device, and current connector is electrically connecting the anode current collector for the first device with the cathode current collector or the second device;
such that the interconnect structure is within the chamber within the reducing atmosphere.
